(19) United States
(12) Patent Application Publication
(10) Pub. No.: US 2017/0210276 A1
(43) Pub. Date: Jul. 27, 2017

(54) DUAL-MODE BACKUP SAFETY LIGHTING, VEHICLE WITH DUAL-MODE BACKUP SAFETY LIGHTING AND METHOD OF OPERATING A VEHICLE

(71) Applicant: Robert DeCote, HOLLYWOOD, FL (US)

(72) Inventor: Robert DeCote, HOLLYWOOD, FL (US)

(21) Appl. No.: 15/168,758

(22) Filed: May 31, 2016

Related U.S. Application Data
(60) Provisional application No. 62/281,424, filed on Jan. 21, 2016.

(51) Int. Cl. B60Q 1/00; B60Q 1/48; B60Q 1/30; B60Q 1/38; B60Q 1/26

(52) U.S. Cl. CPC B60Q 1/0076; B60Q 1/38; B60Q 1/2607; B60Q 1/30; B60Q 1/48

(57) ABSTRACT

A motor vehicle lighting configuration has a plurality of backup lights for illuminating an area in a rear of the motor vehicle and a flasher for changing a mode of operation of the backup lights from a continuous lighting mode to a flashing mode of light illuminated by the backup lights. A switch is provided for actuating the flasher and thus changing a mode of operation of the backup lights. A backup mode indicator is provided for indicating whether the backup lights are in a flashing mode or a continuous lighting mode.

### CROSS-REFERENCE TO RELATED APPLICATION

This application claims the priority, under 35 U.S.C. §119, of U.S. provisional patent application 62/281,424, filed Jan. 21, 2016; the prior application is herewith incorporated by reference in its entirety.

### BACKGROUND OF THE INVENTION

### Field of the Invention

Currently all passenger cars manufactured in the United States, (and, indeed, all over the world) must be manufactured with backup lights that turn on automatically as soon as a car's transmission is placed into reverse gear. Those lights are to go on and stay on continuously—as long as the vehicle remains in reverse gear.

This is what is referred to as a single active-mode for the backup lights. The prior art teaches various single-mode “continuous-on” backup lighting configurations for vehicles. While the configuration of continuously-on backup lights attracts some attention to the rear of a vehicle which is backing up, the fact that 20% of motor vehicle accidents take place in parking lots indicates that there is ample room for improvement in a vehicle's ability to provide a warning signal when it is being backed-up.

Underscoring the above is the fact that far too many people walk through parking lots these days with electronic devices such as cell-phones, smart-phones, i-phones, etc. activated while doing such attention-grabbing things as texting, emailing, playing electronic games, etc.

Therefore many drivers are apprehensive when backing-up in one of today's sizeable and often hectic parking lots. The contention being made is that this anxiety exists, in large measure, because backup lighting in today's cars has not been updated for present times. In fact, motor vehicle backup lighting designs have remained unchanged since Henry Ford's introduction of motor vehicles, approximately one hundred years ago.

### SUMMARY OF THE INVENTION

It is accordingly an object of the invention to provide dual-mode backup safety lighting, a vehicle with dual-mode backup safety lighting and a method of operating a vehicle that overcome the above-mentioned disadvantages of the prior art devices and methods of this general type which is easily installed and at low-cost for assisting in reducing auto accidents and for alerting pedestrians and oncoming traffic to a backing up vehicle.

With the foregoing and other objects in view there is provided, in accordance with the invention, a motor vehicle lighting configuration. The lighting configuration contains a pair of backup lights for illuminating an area in a rear of the motor vehicle and a flasher for changing a mode of operation of the backup light from a continuous lighting mode to a flashing light mode illuminated by the backup light. A switch is providing for actuating the flasher and thus changing a mode of operation of the backup light.

The contention made here is that providing flashing backup lights will aid pedestrian and behind-the-car-traffic because they constitute a much better attention-grabber than the constantly-on backup lights which we're still using.

In a well-lit parking lot (lit, either by daylight or by electric lights at night), a driver can see where he's going, even if he were to turn off all of his lights; so the need for backup lighting in those situations is generally not needed. However, the opposite effect is true for pedestrians maneuvering cautiously behind rows of parked vehicles. In this case, the better lit the parking lot is, the more difficult it becomes for pedestrians and/or other nearby drivers to notice a moving motor vehicle's continuously-lit backup lights; which goes a long-way towards explaining why so many accidents occur in today's crowded, (and, unfortunately) well-lit parking lots. The invention solves this problem by flashing the backup lights instead of keeping them constantly on. In this manner, the vehicle is significantly more readily noticed by pedestrian traffic and oncoming traffic.

In accordance with an added feature of the invention, an indicator is provided for indicating that the flasher is operational and the backup light is either flashing or continuously lit. Ideally, the indicator is an LED light disposed in an interior of the motor vehicle.

In accordance with another feature of the invention, a bypass path is provided for bypassing the flasher and allowing the backup lights to illuminate continuously.

In accordance with a further feature of the invention, the switch has an actuator disposed in an interior of the motor vehicle accessible by a driver, the actuator allowing the driver to choose between the continuous light mode and the flashing mode of the backup light. Ideally, the indicator is integrated into the actuator (e.g. disposed on a surface of the switch body).

With the foregoing and other objects in view there is provided, in accordance with the invention, a method of operating a motor vehicle having a plurality of backup lights for illuminating an area in a rear of the motor vehicle and a flasher for changing a mode of operation of the backup lights. The method includes selecting a backup lighting mode selected from the group consisting of a continuous lighting mode and a flashing lighting mode; and actuating the backup lights based on a selected backup lighting mode.

Other features which are considered as characteristic for the invention are set forth in the appended claims.

Although the invention is illustrated and described herein as embodied in dual-mode backup safety lighting, a vehicle with dual-mode backup safety lighting and a method of operating a vehicle for enhanced motor vehicle safety, it is nevertheless not intended to be limited to the details shown, since various modifications and design changes may be made therein without departing from the spirit of the invention and within the scope and range of equivalents of the claims.

The construction and method of operation of the invention, however, together with additional objects and advantages thereof will be best understood from the following description of a specific embodiment when read in connection with the accompanying drawings.

### BRIEF DESCRIPTION OF THE DRAWINGS

FIG. 1 is a schematic illustration of a single mode backup light configuration according to the prior art; and

FIG. 2 is a schematic illustration of a first embodiment of a dual mode backup light configuration according to the invention.

### DETAILED DESCRIPTION OF THE INVENTION

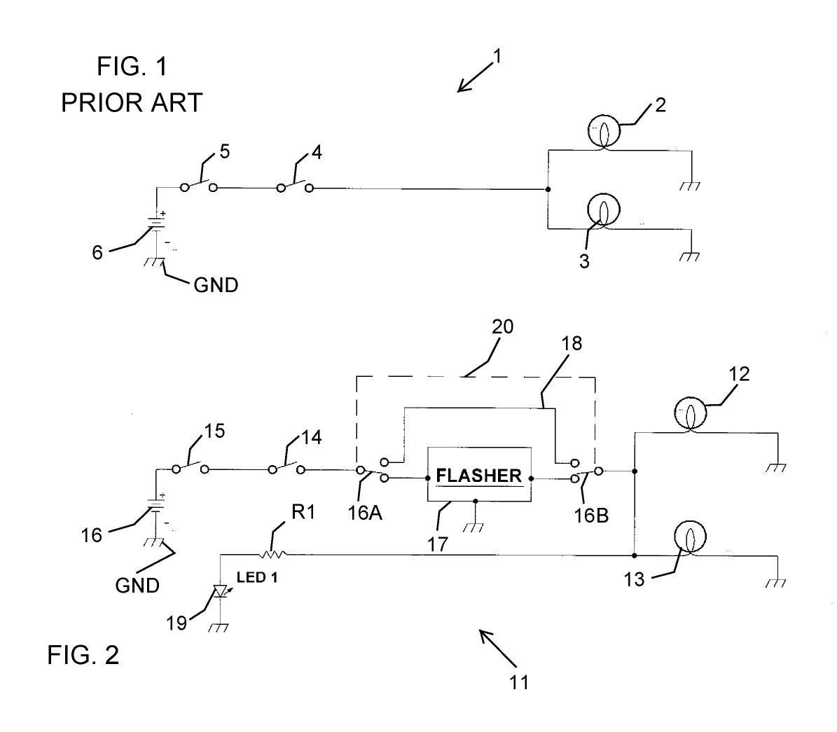

Referring now to the figures of the drawings in detail and first, particularly to FIG. 1 thereof, there is shown a prior art backup lighting configuration 1 nearly-ubiquitous on today's motor vehicles. The backup lighting configuration 1 contains left and right backup lights 2, 3. The backup lights 2, 3 are actuated by a series connection of switches 4, 5 which includes a backup switch 4 and an ignition switch 5. The ignition switch 5 is triggered or switched closed upon the actuation of the motor vehicle while the backup switch 4 is actuated (e.g. closed) upon placing the transmission into a reverse gear. Thus, the motor vehicle battery 6 is in series with the ignition switch 5 and the backup switch 4, which are wired in series with the pair of parallel connected backup lights 2, 3 completing a circuit to ground GND.

Once the motor vehicle is placed in the reverse gear, the backup lights 2, 3 turn on automatically, and they stay on continuously until the vehicle is taken out of the reverse gear. No other active backup lighting modality is available.

This type of backup lighting is simple and is still effective on rural roads and/or for curbside parking, at night. However, this type of backup lighting was configured primarily to illuminate the area directly behind the vehicle to help a driver see where he/she is going.

However, today there are many large and crowded parking lots close to shopping centers, hospitals, hotels, theatres, congregation centers, etc. Not only do these jammed parking lots present new problems for avoiding auto-to-auto collisions, they also present even more serious, life-and-limb threatening problems to pedestrians (children, adults, elderly and informed persons, etc.) who must pass behind rows of parked cars, on high alert, so as to avoid any backing up vehicles.

It's the contention here that this modern, often congested, type of driving environment requires an updated backup lighting configuration. This new configuration of backup lighting is provided, not to aid the driver, but primarily to serve as an enhanced warning signal to nearby pedestrians and/or other motor vehicles.

FIG. 2 shows an embodiment of a dual-mode lighting configuration 11 according to the invention. In this configuration, the vehicle is equipped with a pair of regular white backup lights 12, 13, as in current use, and the driver has the option to select, at the flip of a switch 16A, 16B, either of two backup lighting modes, as follows:

Mode 1—the regular white backup lights 12, 13 stay on continuously.

Mode 2—the regular white backup lights 12, 13 flash repeatedly.

A battery 16 of the motor vehicle is in series with an ignition switch 15 and a backup switch 14 plus a flasher 17, which are wired in series with the pair of parallel connected backup lights 12, 13, completing the circuit to ground GND.

With a double-pole, double-throw (DPDT) mode selector switch 16A, 16B in the position shown and when the ignition switch 15 and the reverse gear backup switch 14 are closed, the backup lights 12, 13 flash repeatedly instead of being constantly on.

With the DPDT mode selector switch 16A, 16B in the alternate position, when the ignition switch 15 and the backup switch 14 are closed, the backup lights 12, 13 stay on continuously because a bypass path 18 goes around the flasher 17.

A backup mode indicator formed of a light emitting diode LED 19 and a current-limiting resistor R1 have been included in order to provide the driver with a real-time visual indication of the active backup lighting mode, flashing or continuous operation of the LED 19 matching the operation of the backup lights 12, 13. Of course many other indicators are also possible in addition to the LED 19.

An actuator 20 of the switch 16A, 16B is provided on the dashboard, instrument panel or front console. By pressing the actuator 20, the driver can chose between the flashing and continuous operation modes. Ideally, the actuator 20 and the LED 19 are integrated as a single unit (LED light built into the surface of the actuator 20). The backup mode indicating diode LED 19 should be mounted near where the driver can easily see it, but not be so bright or conspicuously located as to interfere, in any manner. Ideally, the actuator 20 and the LED 19 are mounted in an area of an instrument panel, dashboard or the front console. In an alternative embodiment, the driver can set the mode of the backup lights in his preset vehicle operating options chosen from a preset list and thus choose between flashing and continuous operating mode and thus no dashboard mounted actuator 20 would be necessary.

Clearly there are many other possible dual-mode configurations than the dual-mode configuration that has been discussed. Anyone of average skill in the art of circuit design can design other dual-mode configurations, such as (a) using a 3PDT switch configuration so that the backup mode indicator LED optionally turns on continuously in mode 1, or (b) using two or more flashers, asynchronous left/right light flashing action can be achieved, or (c) designing a configuration in which both white and amber lights stay on continuously in Mode 1 and flash synchronously. The basic idea presented here is to provide some sort of dual-mode backup lighting for increased backup safety.

The dual-mode backup wiring, as described in the foregoing, has the now described factors in its favor.

First, flashing lights provide a significant improvement in vehicle backup signaling. Therefore, its ready access as a switchable option will unquestionably save lives, prevent personal injuries and help avoid auto-to-auto collisions.

Second, the dual-mode backup lighting is not only simple to incorporate in new motor vehicles, rolling off the production line, it can also be readily installed in existing motor vehicles.

Third, either way, the dual-mode backup lighting can be incorporated at very low-cost using readily available components.

The basic idea presented here is to re-configure today's motor vehicles for a much-needed update; the option to easily choose from either of two backup lighting modes;

Mode 1: A continuously-on type of backup-lighting;—designed primarily to assist the vehicle's driver in dark and sparsely populated situations, typified by night-time curbside parking.

Mode 2: A flashing type of backup-signal-light-warning;—designed primarily to alert, and thereby protect, nearby pedestrians and/or other motor vehicles in either dark or well-lit situations, typified by crowded, busy and tightly laid-out parking lots.

Please note that there are only four new components required for implementing the invention, they are the switch 16A, 16B, 20 the flasher 17, the LED 19 and the current limiting resistor R1.

1. A motor vehicle lighting configuration, comprising:
at least one backup light for illuminating an area in a rear of a motor vehicle;
a flasher for changing a mode of operation of said backup light from a continuous lighting mode to a flashing mode of light illuminated by said backup light; and
a switch for engaging or bypassing said flasher.

2. The motor vehicle lighting configuration according to claim 1, further comprising an indicator for indicating that said flasher is operational and said backup light is flashing.

3. The motor vehicle lighting configuration according to claim 1, further comprising a bypass path for bypassing said flasher and allowing said backup light to illuminate continuously.

4. The motor vehicle lighting configuration according to claim 2, wherein:
said indicator is an LED light disposed in an interior of the motor vehicle; and
said at least one backup light is one of a plurality of backup lights.

5. The motor vehicle lighting configuration according to claim 2, wherein said switch has an actuator disposed in an interior of the motor vehicle accessible by a driver, said actuator allowing the driver to choose between the continuous light mode or the flashing mode of said backup light.

6. The motor vehicle lighting configuration according to claim 5, wherein said indicator is integrated into said actuator.

7. A motor vehicle, comprising:
a plurality of backup lights for illuminating an area in a rear of the motor vehicle;
a flasher for changing a mode of operation of said backup lights from a continuous lighting mode to a flashing mode of light illuminated by said backup lights; and
a switch for actuating said flasher.

8. The motor vehicle lighting configuration according to claim 7, further comprising an indicator for indicating that said backup lights are either flashing or are continuously lit.

9. The motor vehicle lighting configuration according to claim 7, further comprising a bypass path for bypassing said flasher and allowing said backup lights to illuminate continuously.

10. A method of operating a motor vehicle having a plurality of backup lights for illuminating an area in a rear of the motor vehicle and a flasher for changing a mode of operation of the backup lights, which comprises the steps of:
selecting a backup lighting mode selected from the group consisting of a continuous lighting mode and a flashing lighting mode; and
actuating the backup lights based on a selected backup lighting mode.
